(19) United States
(12) Patent Application Publication
(10) Pub. No.: US 2026/0351254 A1
(43) Pub. Date: Nov. 5, 2026

(54) EXTENSIBLE CONVERSATIONAL SYSTEM INTELLIGENCE AGENT

(71) Applicant: Google LLC, Mountain View, CA (US)

(72) Inventors: Nicu Daniel Cornea, Santa Clara, CA (US); Tony Freeman Kinnis, San Jose, CA (US)

(21) Appl. No.: 19/194,279

(22) Filed: Apr. 30, 2025

(51) Int. Cl. G10L 15/22

(52) U.S. Cl. CPC G10L 15/22; G10L 2015/223

(57) ABSTRACT

According to an aspect, a method includes receiving, by an agent included on a computing device, input text as a sequence of words based on voice data that indicates an action for performing on the computing device. A method may include determining, by the agent, how to perform the action on the computing device, the determining including accessing a capabilities application programming interface for interfacing with a capabilities repository, identifying at least one capability included in the capabilities repository for use in performing the action, and determining that an application associated with the at least one capability is installed on the computing device. A method may include launching the application on the computing device, the launching performing the action on the computing device.

### BACKGROUND

A television (TV) application may present various types of media content of interest to a user. The media content may have different formats such as streaming video and audio. The types of media content may include, but are not limited to, movies, television shows, sporting events, news items, short form videos, and music. In addition, or in the alternative, a variety of media content providers may deliver various types of media content for viewing by the user. The TV application may deliver a customized viewing experience to a user that spans the diverse types of media content provided by the variety of media content providers.

### SUMMARY

In some aspects, the techniques described herein relate to a method including: receiving, by an agent included on a computing device, input text as a sequence of words based on voice data that indicates an action for performing on the computing device; determining, by the agent, how to perform the action on the computing device, the determining including: accessing a capabilities application programming interface for interfacing with a capabilities repository; identifying at least one capability included in the capabilities repository for use in performing the action; and determining that an application associated with the at least one capability is installed on the computing device; and launching the application on the computing device, the launching performing the action on the computing device.

In some aspects, the techniques described herein relate to a method, further including: receiving, by the agent, a structured formatted file that includes capabilities associated with the application; and including the capabilities in the capabilities repository in association with the application.

In some aspects, the techniques described herein relate to a method, further including, based on analyzing a screen shot of an application executing in the computing device, determining at least one capability for including in the capabilities repository in association with the application.

In some aspects, the techniques described herein relate to a method, further including synchronizing another capabilities repository included on another computing device with the capabilities repository, the synchronizing providing cross-device capabilities.

In some aspects, the techniques described herein relate to a method, wherein the voice data is provided by a remote control device communicatively coupled to the computing device.

In some aspects, the techniques described herein relate to a method, wherein determining how to perform the action on the computing device further includes: identifying at least one capability included in a central capabilities repository for use in performing the action; determining that an application associated with the at least one capability included in the central capabilities repository is included in a web store application repository; and sending a request to an application server to download the application associated with the at least one capability included in the central capabilities repository to the computing device.

In some aspects, the techniques described herein relate to a method, wherein determining how to perform the action on the computing device further includes: accessing a context application programming interface for interfacing with a context repository; and identifying at least one context included in the context repository for use in performing the action.

In some aspects, the techniques described herein relate to a method, further including determining that the input text is a phrase associated with the application.

In some aspects, the techniques described herein relate to a method, wherein the computing device is a smart television.

In some aspects, the techniques described herein relate to a non-transitory computer-readable medium storing executable instructions that when executed by at least one processor of a computing device cause the at least one processor to execute operations, the operations including: receiving, by an agent included on the computing device, input text as a sequence of words based on voice data that indicates an action for performing on the computing device; determining, by the agent, how to perform the action on the computing device, the determining including: accessing a capabilities application programming interface for interfacing with a capabilities repository; identifying at least one capability included in the capabilities repository for use in performing the action; and determining that an application associated with the at least one capability is installed on the computing device; and launching the application on the computing device, the launching performing the action on the computing device.

In some aspects, the techniques described herein relate to a non-transitory computer-readable medium, wherein the operations further include: receiving, by the agent, a structured formatted file that includes capabilities associated with the application; and including the capabilities in the capabilities repository in association with the application.

In some aspects, the techniques described herein relate to a non-transitory computer-readable medium, wherein the operations further include, based on analyzing a screen shot of an application executing in the computing device, determining at least one capability for including in the capabilities repository in association with the application.

In some aspects, the techniques described herein relate to a non-transitory computer-readable medium, wherein the operations further include synchronizing another capabilities repository included on another computing device with the capabilities repository, the synchronizing providing cross-device capabilities.

In some aspects, the techniques described herein relate to a non-transitory computer-readable medium, wherein the voice data is provided by a remote control device communicatively coupled to the computing device.

In some aspects, the techniques described herein relate to a non-transitory computer-readable medium, wherein determining how to perform the action on the computing device further includes: identifying at least one capability included in a central capabilities repository for use in performing the action; determining that an application associated with the at least one capability included in the central capabilities repository is included in a web store application repository; and sending a request to an application server to download the application associated with the at least one capability included in the central capabilities repository to the computing device.

In some aspects, the techniques described herein relate to a non-transitory computer-readable medium, wherein determining how to perform the action on the computing device further includes: accessing a context application programming interface for interfacing with a context repository; and identifying at least one context included in the context repository for use in performing the action.

In some aspects, the techniques described herein relate to a system including: at least one processor; and a non-transitory computer-readable medium storing instructions that when executed by the at least one processor cause the system to: receive input text as a sequence of words based on voice data that indicates an action for performing on the system; determine how to perform the action on the system, the determining including: accessing a capabilities application programming interface for interfacing with a capabilities repository; identifying at least one capability included in the capabilities repository for use in performing the action; and determining that an application associated with the at least one capability is installed on the system; and launch the application on the system, the launching performing the action on the system.

In some aspects, the techniques described herein relate to a system, wherein the instructions when executed by the at least one processor further cause the system to: receive a structured formatted file that includes capabilities associated with the application; and include the capabilities in the capabilities repository in association with the application.

In some aspects, the techniques described herein relate to a system, wherein the instructions when executed by the at least one processor further cause the system to, based on analyzing a screen shot of an application executing in the system, determine at least one capability for including in the capabilities repository in association with the application.

In some aspects, the techniques described herein relate to a system, wherein the instructions when executed by the at least one processor further cause the system to synchronize another capabilities repository included on another system with the capabilities repository, the synchronizing providing cross-device capabilities.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example of a user interacting with a network-connected display device and a media adapter, according to implementations described throughout this disclosure.

FIG. 1B illustrates an example of a user interface displayed on a network-connected display device in response to voice commands according to implementations described throughout this disclosure.

FIG. 1C illustrates an example system for implementing an extension mechanism for expanding the conversational capabilities of network-connected display device according to implementations described throughout this disclosure.

FIG. 2 is an illustration of an example conversational system intelligence agent according to implementations described throughout this disclosure.

FIG. 3 is an illustration of an example structured format for declaring or publishing the capabilities of an application to a capabilities API for inclusion in a capabilities repository according to implementations described throughout this disclosure.

FIG. 4 is an illustration of an example user interface for a television application that may be displayed on a display of a computing device of a user while the television application is running or executing on the computing device according to implementations described throughout this disclosure.

FIG. 5 is an illustration of an example structured format for declaring or publishing the context of an application to a context API for inclusion in a context repository according to implementations described throughout this disclosure.

FIG. 6 illustrates a flowchart depicting example operations for implementing an extensible conversational system intelligence agent according to implementations described throughout this disclosure.

### DETAILED DESCRIPTION

A user may launch and interact with a TV application on many different computing devices such as a smart phone, a tablet computer, a laptop computer, and a smart television (TV). The computing device may include voice assisted capabilities that allow the user to interact with the computing device by providing voice commands and instructions. In some implementations, the voice assisted capabilities provided by the computing device may be limited to a set of bespoke features provided by a voice-based assistant and/or a set of bespoke features provided by developers of applications that may run on the computing device. Because of the limited voice assisted capabilities, the available functionality of voice-based interactions of the user with the computing device may be restricted to the features implemented by the application developers as each new feature may require a new engineering effort.

In addition, or in the alternative, voice assisted capabilities may be extended based on the functionality of applications that may run on the computing device by using Application Programming Interfaces (APIs) that allow the applications to communicate and exchange data, features, and functionality with each other. In some implementations, however, the integration models for the applications may require that the user formulate a voice-based request in a specific way to invoke a particular extension of the voice-based capability. The functionality of voice-based interactions, therefore, may lack true conversational capabilities, relying instead on what may be relatively inflexible grammar to trigger specific functions.

In addition, or in the alternative, voice assisted capabilities may be extended by using large language models (LLMs) that may better understand human speech and in turn may provide a more conversational voice assisted capability to the user. In some implementations, a large language model may support application developer extensions in the form of function calling, which may allow the application developer to enhance the capabilities of the LLM. The capabilities of the LLM, however, may be associated with a specific application domain limiting the capabilities of the LLM to that specific application domain. Therefore, the LLM may not make use of capabilities that may be provided by another application domain. For example, in these implementations, the LLM determined by the application developer to be the more capable LLM for providing the conversational voice assisted capability to the user may then be used to implement a conversational system intelligence agent, which is different from other conversational system intelligence agents that use other LLMs associated with other application domains that have different capabilities.

An application developer may be faced with the technical problem of how to add new capabilities to a single conversational system intelligence agent for an application to improve and enhance the capabilities of the single conversational system intelligence agent and the overall application. The new and improved capabilities of the single conversational system intelligence agent may enhance the experience of the user with the application. At least one technical problem may be how a single conversational system intelligence agent may utilize the capabilities of multiple LLMs that are each associated with different application domains to enhance and improve the capabilities implemented by the single conversational system intelligence agent.

At least one technical solution may be to allow an application to expose, advertise, share, and/or publish functionality supported by the application (e.g., schemas) so that other applications may be aware of the available functionality. At least one technical solution may include systems and methods for use by applications for exposing, advertising, sharing, and/or publishing functionality supported by the application that may not include maintaining a set of allowed functionalities. In addition, or in the alternative, at least one technical solution may include mechanisms for use by a conversational system intelligence agent for an application to discover any exposed, advertised, shared, and/or published functionality of other applications across different computing devices of a user. In addition, or in the alternative, at least one technical solution may include mechanisms for use by a conversational system intelligence agent for an application to discover any exposed, advertised, shared, and/or published functionality of other applications that may not yet be installed on any computing devices of the user.

At least one technical effect may include providing an extension mechanism for a conversational system intelligence agent for an application that improves a conversational voice assisted capability of the application. The extension mechanism may extend and expand the built-in capabilities of the conversational system intelligence agent by interfacing with and utilizing the discovered functionality of other applications across different computing devices as well as across applications that may not even be installed on any of the computing devices of the user. The improvement may increase the quality of user interactions with the application by supporting more natural language based conversations.

In some implementations, as described herein, a computing device may include a conversational system intelligence agent that implements an extension mechanism for expanding the conversational capabilities of the computing device with a user by utilizing the capabilities of LLMs that are associated with other applications. Each extension may enhance the capabilities of the conversational system intelligence agent for an application by combining the capabilities of the conversational system intelligence agent with the available extensions of other applications thus enabling more rewarding and complex interactions of the user with the application.

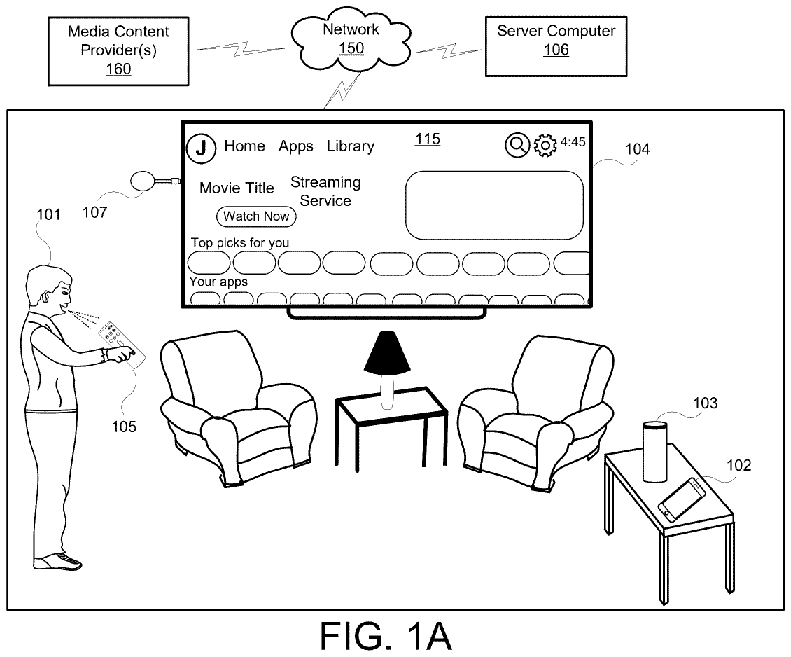

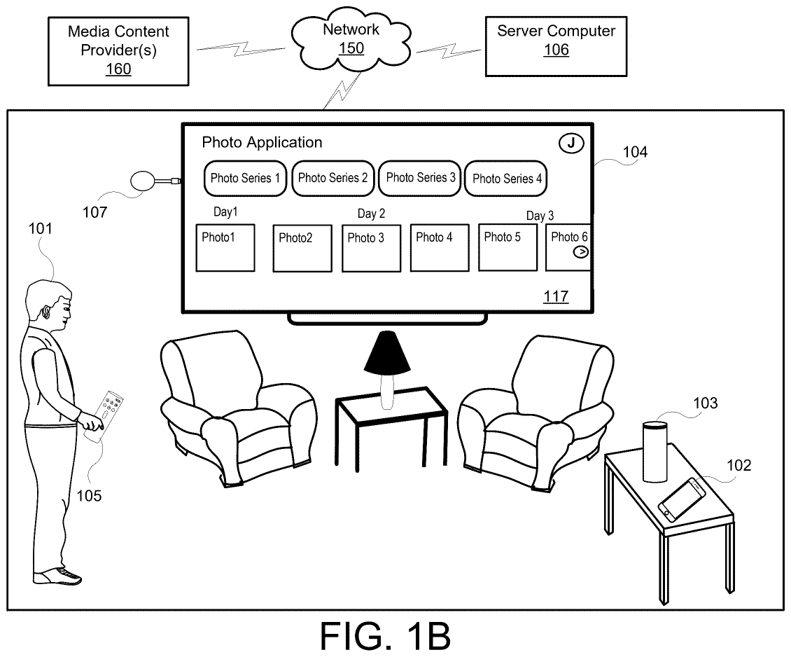

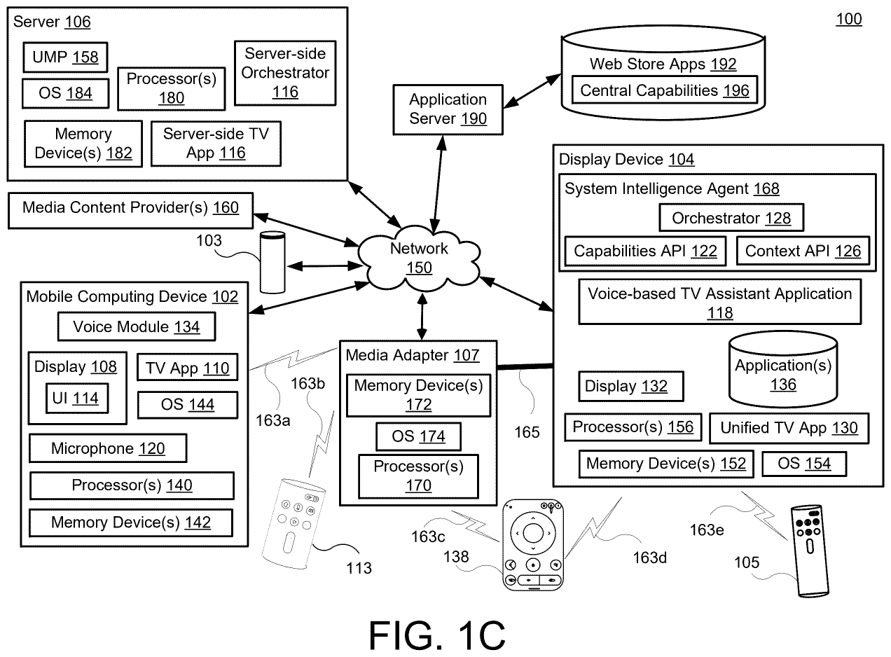

FIG. 1A illustrates an example of a user 101 interacting with a remote control device 105 to provide voice commands to a network-connected display device 104 according to implementations described throughout this disclosure. FIG. 1B illustrates an example of a user interface 117 displayed on the network-connected display device 104 in response to the voice commands according to implementations described throughout this disclosure. FIG. 1C illustrates an example system 100 for implementing an extension mechanism for expanding the conversational capabilities of network-connected display device 104 according to implementations described throughout this disclosure.

Referring to FIGS. 1A-C, the network-connected display device 104 may communicate with a server computer 106 and media content providers 160 by way of the network 150. The media content providers 160, the network-connected display device 104, the server computer 106, and a mobile computing device 102 may interact with and communicate with one other by way of the network 150. In some implementations, the mobile computing device 102 may interface or connect to the media adapter 107 and/or the network-connected display device 104 by way of a wireless communication link that may be a short-range wireless connection such as, for example, a Bluetooth connection or a Wi-Fi (e.g., direct Wi-Fi) connection.

In some implementations, the user 101 may interact with the network-connected display device 104 using the remote control device 105. In some implementations, a television (TV) application 110 running on the mobile computing device 102 may render a virtual remote control 138 in a user interface (e.g., UI 114) on a display (e.g., a mobile computing device display 108) on the mobile computing device 102. The virtual remote control 138 may allow the mobile computing device 102 to act as a remote control for the network-connected display device 104. The TV application 110 may render the virtual remote control 138 for use with the network-connected display device 104.

In some implementations, the user 101 may interact with a voice-based television (TV) assistant application 118 included on the network-connected display device 104. For example, the voice-based TV assistant application 118 may receive voice data or commands from voice input devices that include a microphone such as the remote control device 105 or a smart speaker 103. For example, the user 101 may provide spoken words into microphones included in the voice input devices. The voice input devices may send, transmit, or provide the spoken words as voice data to voice modules or applications running on computing devices in communication with the voice input devices. In some implementations, the network-connected display device 104 may include a voice input device. In some implementations, the mobile computing device 102 may provide the virtual remote control 138 in the UI 114 on the mobile computing device display 108 that allows the mobile computing device 102 to act as a remote control for the network-connected display device 104.

In some implementations, the voice-based TV assistant application 118 may receive voice data or commands from the mobile computing device 102 when acting as a remote control for the network-connected display device 104. For example, a microphone 120 included on the mobile computing device 102 may receive verbal commands or voice data from the user 101. In some implementations, a voice module 134 may send the voice data to the network-connected display device 104 by way of the network 150. In some implementations, the voice module 134 may send the voice data to the network-connected display device 104 by way of a wireless communication link (e.g., wireless communication link 163d).

A user may speak into a voice input device providing spoken word voice commands. The voice-based television assistant application 118 may receive voice data from the voice input devices. The voice-based TV assistant application 118 may process the voice data or human speech to provide textual input (input text) as a sequence of words to a unified television application 130 running on the network-connected display device 104. For example, the user 101 may launch the unified television application 130. The unified television application 130 may provide a user interface 115 on a display 132 of the network-connected display device 104.

In some implementations, the voice-based TV assistant application 118 may perform natural language processing to convert the human speech into the sequence of words. In some implementations, the voice-based TV assistant application 118 may be included in the smart speaker 103. In some implementations, the voice-based TV assistant application 118 may be included in the remote control device 105. In some implementations, the voice-based TV assistant application 118 may be included in the voice module 134 on the mobile computing device 102. The sequence of words may be input text representative of the verbal input received by the voice input device.

Referring to FIG. 1C, the network-connected display device 104 may include a conversational system intelligence agent (e.g., agent 168). The agent 168 may be a LLM included on the network-connected display device 104 that may include extensions provided by other applications that improve the performance of the conversational capabilities of the network-connected display device 104.

The system 100 may implement an extension mechanism for the agent 168 that expands the built-in capabilities of the agent 168 with new capabilities provided by one or more applications. The capabilities of the agent 168 may incrementally improve with each newly added application extension for use by the agent 168. Therefore, the agent 168 may become increasingly more capable as more applications provide the use of the LLMs associated with each application for use by the agent 168. The improvement in the capabilities of the agent 168 may result in the unified television application 130 providing an enriched user experience to the user 101 when interacting with the unified television application 130 on the network-connected display device 104.

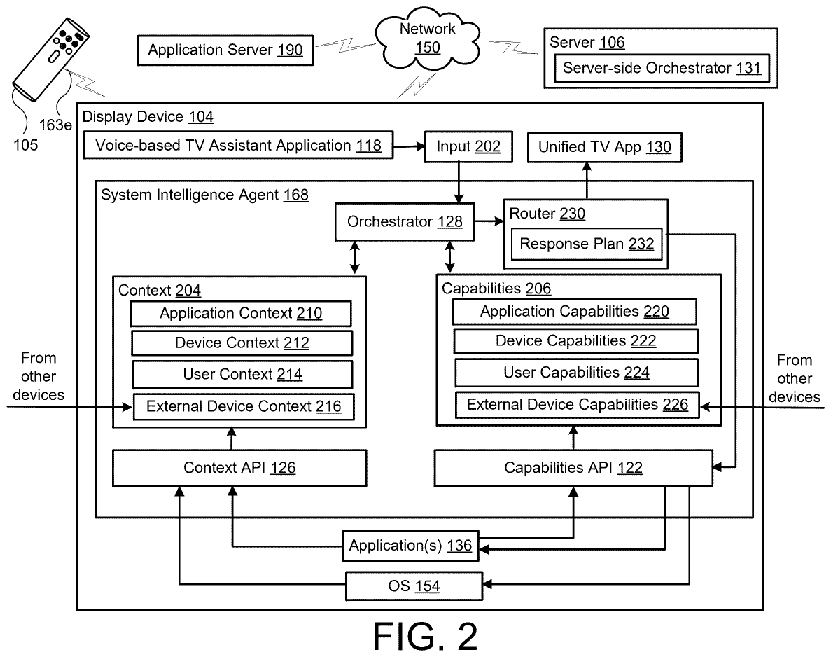

FIG. 2 is an illustration of an example conversational system intelligence agent (e.g., the agent 168 as shown in FIG. 1C) according to implementations described throughout this disclosure. For example, referring to FIGS. 1A-C and 2, the agent 168 may include an orchestrator 128, a capabilities application programming interface (API) 122, and a context application programming interface (API) 126.

The user 101 may access the newly added capabilities for the unified television application 130 by way of the agent 168 interfacing with the voice-based TV assistant application 118 and the unified television application 130. The voice-based television assistant application 118 may receive the voice data from one or more voice input devices of the user 101. The voice-based TV assistant application 118 may process the voice data or human speech as described herein and output a sequence of words as text for input (e.g., input 202) to the agent 168.

The capabilities API 122 may interface with a repository of application capabilities (e.g., capabilities repository 206). An application that is installed on the network-connected display device 104 may make the capabilities of the application known to the agent 168 for inclusion in the capabilities repository 206. The applications installed on the network-connected display device 104 may be included in an application repository 136.

An application installed on another computing device of the user but that is not installed on the network-connected display device 104 make the capabilities of the application known to the agent 168 for inclusion in the capabilities repository 206. An application that is not installed on any of the computing devices of the user may make the capabilities of the application known to the agent 168 for inclusion in the capabilities repository 206. In some implementations, applications not installed on the network-connected display device 104 may be provided by an application server 190 at the request of the user 101 and may be downloaded to the network-connected display device 104 for inclusion in the application repository 136.

The capabilities repository 206 may include capabilities that include, but are not limited to, application capabilities included in an application capabilities module 220, device capabilities included in a device capabilities module 222, user capabilities included in a user capabilities module 224, and cross-device capabilities included in a cross-device capabilities module 226. An application may make the capabilities of the application known to an agent included in a computing device of a user by declaring the capabilities of the application in a structured format (e.g., a structured formatted file), and/or by allowing the agent to take a screen shot of the application as the application is running on the computing device.

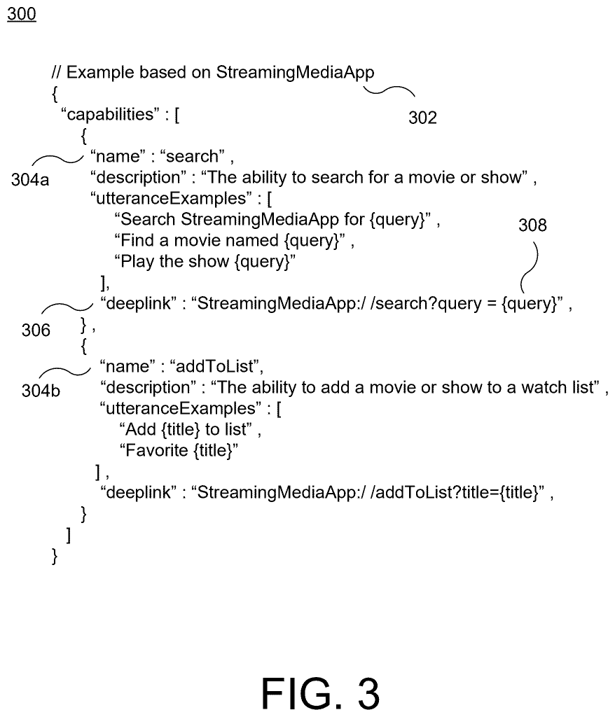

FIG. 3 is an illustration of an example structured format 300 for declaring or publishing the capabilities of an application to a capabilities API for inclusion in a capabilities repository according to implementations described throughout this disclosure. The structured format 300 may be included in a structured formatted file included in a package that includes the application. For example, referring to FIGS. 1A-C and 2, a streaming media application 302 may be included in the application repository 136 on the network-connected display device 104. The streaming media application 302 may make the capabilities of the streaming media application 302 known to the capabilities API 122 for inclusion as application capabilities in the application capabilities module 220 in the capabilities repository 206. The structured format 300 may include descriptions of application capabilities 304a-b for the streaming media application 302 such as a search capability 304a and an add to list capability 304b. An application (e.g., the streaming media application 302) may declare the capabilities of the application in a structured format such as, for example, in a file included in a package that includes the application (e.g., a capabilities. json file included in the application package as shown in the example structured format 300). The search capability 304a and the add to list capability 304b may be included as application capabilities in the application capabilities module 220 in the capabilities repository 206 for use by the orchestrator 128 allowing the agent 168 to discover and utilize the capabilities of the streaming media application 302 to enhance and enrich the capabilities of the agent 168.

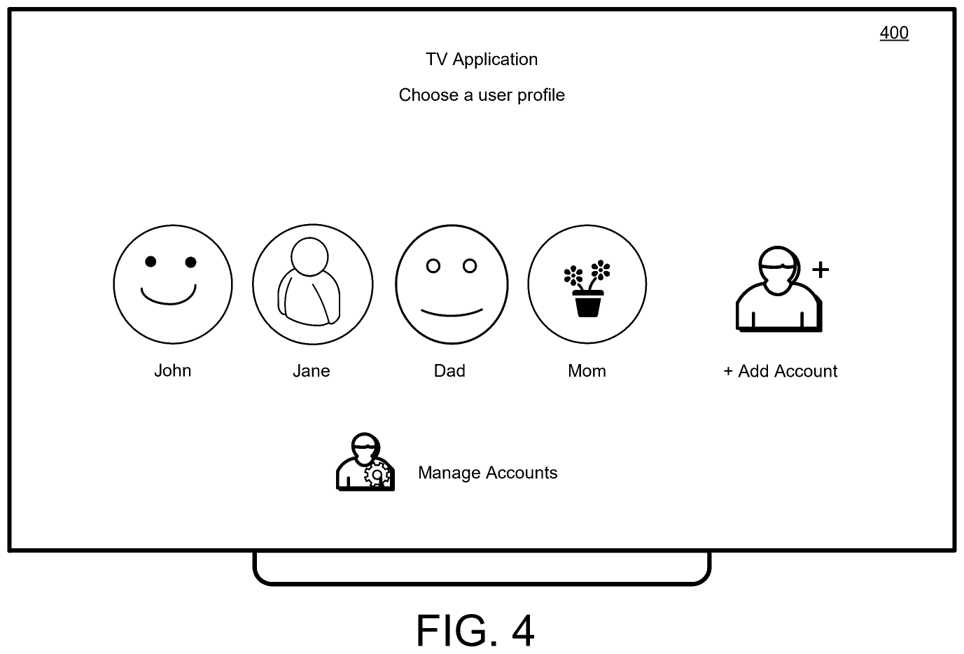

FIG. 4 is an illustration of an example user interface 400 for a television (TV) application (e.g., unified television application 130) that may be displayed on a display(e.g., display 132) of a computing device (e.g., the network-connected display device 104) of a user (e.g., the user 101) while the TV application (e.g., the unified television application 130) is running or executing on the computing device (e.g., the network-connected display device 104) according to implementations described throughout this disclosure. For example, referring to FIGS. 1A-C and 2, the unified television application 130 may allow the agent 168 to take a screenshot of the user interface 400. The agent 168 may analyze the screenshot of the user interface 400 to determine the capabilities of the application in the current context of the unified television application 130. For example, the user interface 400 is for the selection of a user profile for the unified television application 130. Therefore, if the user 101 says “select John's profile,” the agent 168 may direct the unified television application 130 to select the profile for the user “John.”

In some implementations, the agent 168 may determine the capabilities of an application by way of the capabilities API 122. The agent 168 may be made aware of the capabilities of an application (e.g., the application publishes or otherwise shares the capabilities of the application) when the application is installed or included in the application repository 136. In addition, or in the alternative, the agent 168 may be made aware of the capabilities of an application when the application is running or executing on the network-connected display device 104 by analyzing a screen shot of the application as the application is running on the network-connected display device 104.

Referring to FIG. 3, the streaming media application 302 may be included in the application repository 136 on the network-connected display device 104. The streaming media application 302 may make the capabilities of the streaming media application 302 known to the capabilities API 122 for inclusion as application capabilities in the application capabilities module 220 in the capabilities repository 206 even if the streaming media application 302 though included in the application repository 136 may not be running or executing on the network-connected display device 104 when the streaming media application 302 makes the capabilities of the streaming media application 302 known to the capabilities API 122. Referring to FIG. 4, the unified television application 130 may be running or executing on the network-connected display device 104 but may not make the capabilities of the unified television application 130 known to the capabilities API 122 The agent 168 may take a screen shot of the unified television application 130 while the unified television application 130 is running on the network-connected display device 104. By analyzing a screen shot of the application as the application is running on the network-connected display device 104, the agent 168 may determine the capabilities of the unified television application 130 in a current context of the unified television application 130.

The agent 168 may determine the capabilities of the applications installed on a computing device of the user (e.g., the applications included in the application repository 136 on the network-connected display device 104) if the application makes the capabilities of the application known to the capabilities API 122 (as in the example of FIG. 3) or by analyzing a screen shot of the application as the application is running or executing on the computing device of the user (as in the example of FIG. 4). In some implementations, a user may use or own multiple computing devices. For example, the network-connected display device 104 may be a smart TV. The user may also use, own, or be associated with additional computing devices such as, for example, a smart phone, a tablet computer, or a laptop computer. The capabilities repository 206 may include cross-device capabilities in a cross-device capabilities module 226. The cross-device capabilities included in the cross-device capabilities module 226 may enable the conversational system intelligence agents included on the other computing devices of the user to synchronize the capabilities repositories on each of the other devices with the capabilities repository 206 on the network-connected display device 104. The cross-device capabilities included in the cross-device capabilities module 226 may provide the agent 168 with a complete picture of the capabilities available across the computing devices of the user thus further enhancing the capabilities of the agent 168.

Applications that are not available or installed on any of the computing devices of the user may provide beneficial enhancements to the capabilities of an agent therefore improving the user experience with a conversational system intelligence agent. In some implementations, referring to FIG. 1C, the application server 190 may interface with a central repository of capabilities (e.g., central capabilities repository 196) for applications included in a web store application repository 192. For example, the central capabilities repository 196 may be a repository with application packages that may include a file that declares the capabilities of an application in a structured format. For example, the application package may include a capabilities.json file that includes the capabilities of the application for use by the agent 168. The agent 168 may access the web store application repository 192 by way of the application server 190. The application server 190 may provide the central capabilities repository 196 to the agent 168. The agent 168 may determine if the central capabilities repository 196 includes capabilities for associated applications that may not be installed on the network-connected display device 104 or otherwise available on any of the computing devices of the user (e.g., not included in the cross-device capabilities module 226) but that may be useful to enhance and extend the capabilities of the agent 168 thereby enriching and improving the experience of the user with the agent 168. In some implementations, the agent 168 may suggest that the user 101 download and install an application from the web store application repository 192 based on determining that the capabilities of the application may enhance and improve the performance of the agent 168 by extending the available capabilities for use by the agent 168. Once downloaded and installed, the capabilities of the application may become available for use by the agent 168.

In addition, or in the alternative, for the agent 168 to facilitate the controlling and performing of a verbally requested action by the user 101, the agent 168 may access the capabilities repository 206 using the capabilities API 122 to improve a conversational experience of the user 101 with the network-connected display device 104. In addition to utilizing the capabilities included in the capabilities repository 206, the agent 168 may utilize a context of the user and/or the computing device that includes the agent 168 to further improve the conversational experience of the user 101 with the network-connected display device 104. The agent 168 may interface with the context API 126. The context API 126 may interface with a context repository 204. The context repository 204 may include determining an application currently running on the network-connected display device 104, determining a computing device type for the computing device that includes the agent 168 (e.g., the network-connected display device 104 may be a smart TV), and/or determining a current user context (e.g., a location of the computing device that includes the agent).

The context repository 204 may include contexts that include, but are not limited to, application contexts included in an application context module 210, device contexts included in a device context module 212, user context included in a user context module 214, and cross-device context included in a cross-device context module 216. For example, an application context may be a context of the application that the user 101 is currently interacting with on the network-connected display device 104 (e.g., a foreground application). For example, a device context may be for an environment for the network-connected display device 104 (e.g., a currently selected locale, a location of the network-connected display device 104). For example, a user context may be an identity of the user (e.g., a user email, a user identifier, etc.) and/or previous utterances by the user (e.g., verbal commands or voice data) in a current conversation or interaction with the agent 168 on the network-connected display device 104 (e.g., a conversation context).

In some implementations, a user may use or own multiple computing devices. For example, the network-connected display device 104 may be a smart TV. The user may also use, own, or be associated with additional computing devices such as, for example, a smart phone, a tablet computer, or a laptop computer. For example, a cross-device context may allow the sharing of device contexts across multiple computing devices associated with or owned by the user. The cross-device contexts included in the cross-device context module 216 may provide the agent 168 with a complete picture of context of the computing devices of the user thus further enhancing the performance of the agent 168 in creating enhanced cross-device interactions for the user.

An application may make the context of the application, the user, and/or the computing device that includes the agent 168 known to the agent 168 by declaring the context in a structured format, and/or by allowing the agent 168 to take a screen shot of the application as the application is running on the computing device.

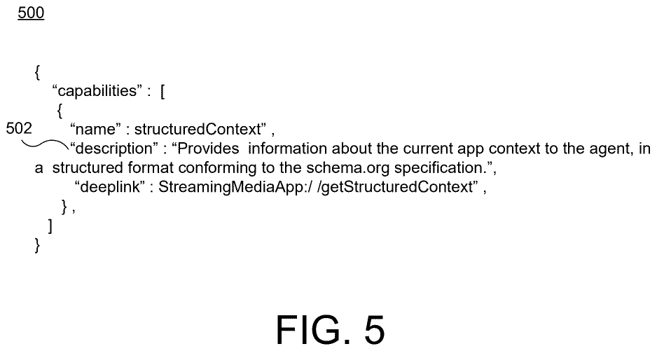

FIG. 5 is an illustration of an example structured format 500 for declaring or publishing the context of an application to a context API for inclusion in a context repository according to implementations described throughout this disclosure. For example, referring to FIGS. 1A-C and 2, a streaming media application 302 may be included in the application repository 136 on the network-connected display device 104. The streaming media application 302 may make the context of the streaming media application 302 known to the context API 126 for inclusion as application context in the application context module 210 in the context repository 204. The structured format 500 may include a description of the application context 502 for the streaming media application 302. An application (e.g., the streaming media application 302) may declare the context of the application in a structured format, for example, in JavaScript Object Notation (JSON) using a schema (e.g., Schema. org) to reference a media content item the streaming media application 302 may be playing on the network-connected display device 104 at the time the user 101 invokes, interfaces, or interacts with the agent 168. The application context 502 may be included as an application context in the application context module 210 in the context repository 204 for use by the orchestrator 128 allowing the agent 168 to discover and utilize the context of the streaming media application 302 to enhance and enrich the performance of the agent 168.

Referring back to FIGS. 1A-C and 2, the agent 168 may include the orchestrator 128. The orchestrator 128 may control the interactions of the agent 168 with the input 202, the context repository 204, the capabilities repository 206, and a router 230. The orchestrator 128 as part of the agent 168 on the network-connected display device 104 may use generative artificial intelligence and LLMs to process contexts for the network-connected display device 104, capabilities for the network-connected display device 104, and the received verbal commands, requests, or voice data from the user 101 (e.g., the input 202) to generate a response plan 232 for implementing by the router 230. The router 230 interfacing with the orchestrator 128 may translate the response plan 232 into one or more actions that may be performed by the agent 168 on the network-connected display device 104.

The actions may include invoking an application capability using an application deep link provided in the structured format file included in the application package with the application. For example, referring to FIG. 3, the “search” application capability (e.g., the search capability 304a) may be invoked by using a deep link 306 provided in the structured format 300 (e.g., the capabilities. json file) of the file for the streaming media application 302, and substituting argument values (e.g., argument value 308) based on the input 202 (e.g., the received verbal commands, requests, or voice data from the user 101).

In addition, or in the alternative, the actions may include making calls to application programming interfaces (APIs) included in the operating system (e.g., the operating system 154). In addition, or in the alternative, the actions may include invoking a capability on another computing device of the user.

In some implementations, the user may have an interactive conversation with the agent 168. In these implementations, the agent 168 may request that the user 101 provide additional information to clarify the request. In addition, or the alternative, the agent 168 may request additional information or inputs such as permission to perform actions on the network-connected display device 104 that may be deemed risky. The agent 168 may interface with the unified television application 130 by way of the router 230. The unified television application 130 may provide the request for additional information from the user in a user interface on the display 132 of the network-connected display device 104. In some implementations, the unified television application 130 may provide the request for additional information from the user to the voice-based TV assistant application 118. The voice-based TV assistant application 118 may convert a text-based request from the unified television application 130 to voice data. For example, the voice-based TV assistant application 118 may provide the voice data to a speaker included on the network-connected display device 104 for playing back to the user 101. For example, in implementations where the mobile computing device 102 is used as a remote control device for the network-connected display device 104, the voice-based TV assistant application 118 may send or provide the voice data to the remote control device 105 for playback to the user 101 on a speaker included on the mobile computing device 102.

Applications that are not available or installed on any of the computing devices of the user may provide beneficial enhancements to the capabilities of an agent therefore improving the user experience with a conversational system intelligence agent. In some implementations, referring to FIG. 1C, the application server 190 may interface with a central repository of capabilities (e.g., central capabilities repository 196) for applications included in a web store application repository 192. For example, the central capabilities repository 196 may be a repository with application packages that may include a file that declares the capabilities of an application in a structured format. For example, the application package may include a capabilities.json file that includes the capabilities of the application for use by the agent 168. The agent 168 may access the web store application repository 192 by way of the application server 190. The application server 190 may provide the central capabilities repository 196 to the agent 168. The agent 168 may determine if the central capabilities repository 196 includes capabilities for associated applications that may not be installed on the network-connected display device 104 or otherwise available on any of the computing devices of the user (e.g., not included in the cross-device capabilities module 226) but that may be useful to enhance and extend the capabilities of the agent 168 thereby enriching and improving the experience of the user with the agent 168. In some implementations, the agent 168 may suggest that the user 101 download and install an application from the web store application repository 192 based on determining that the capabilities of the application may enhance and improve the performance of the agent 168 by extending the available capabilities for use by the agent 168. Once downloaded and installed, the capabilities of the application may become available for use by the agent 168.

Referring to FIGS. 1C and 2, in some implementations, an orchestrator (e.g., the orchestrator 128) may be implemented and executed on the computing device of the user (e.g., network-connected display device 104). In some implementations, a server (e.g., the server computer 106) may include the orchestrator (e.g., server-side orchestrator 131). For example, the server computer 106 may be a cloud-based server. In some implementations, the orchestrator may be implemented in a hybrid on-device/cloud configuration, where some requests are handled on the computing device by the on-device orchestrator (e.g., orchestrator 128), and other requests are handled in the cloud by the server-side orchestrator (e.g., the orchestrator 131). For example, the configuration of the orchestrator in the system 100 may be dictated by the hardware capabilities of the network-connected display device 104.

In a first example, a user may provide a simple voice command to the voice-based TV assistant application 118 as described herein. Referring to FIGS. 1A-B, the user 101 may speak into the microphone on the remote control device 105 and request that the network-connected display device 104 show the user the photos for the user (e.g., “show me my photos”). The voice-based TV assistant application 118 may generate the input 202 based on the request of the user 101. The agent 168 may process the request of the user 101, and may determine that the agent 168 may not be able to fulfill the request of the user. For example, the orchestrator 128 may interface with the router 230 indicating that the agent 168 may not be able to fulfill the request of the user 101. The router 230 may interface with the unified television application 130 to provide a message to the user 101 indicating that the agent 168 may not fulfill the request of the user (e.g., “Sorry, I don't know how to help with that”). The user 101 may then download and install a photo application on the network-connected display device 104. Once the photo application is installed on the network-connected display device 104, the agent 168 may determine and scrape the capabilities of the photo application such as a PhotosLibrarySlideshow capability along with some associated example phrases such as “show my photos library”, “show photos”, and an associated deep link for the photo application. The agent 168 may determine and scrape the capabilities of the photo application by accessing a structured formatted file associated with the application.

Referring to FIG. 1B, when the user 101 speaks into the remote control device 105 and requests that the network-connected display device 104 show the user the photos for the user (e.g., “show me my photos”), the agent 168 maps the request of the user to the PhotosLibrarySlideshow capability of the photo application. The agent 168 using the orchestrator 128 and the router 230 invokes the PhotosLibrarySlideshow capability of the photo application using the deep link provided in the structured formatted file associated with the application. The network-connected display device 104 may display a user interface 117 on the display 132 for the PhotosLibrarySlideshow capability of the photo application.

In a second example, the system 100 may address disambiguation for a request of the user 101. The user 101 may install more than one application capable of providing the photos of the user 101 for viewing in the display 132 of the network-connected display device 104. The application capabilities module 220 may include the capabilities of both applications for providing and displaying the photos of the user. Therefore, when the user 101 requests that the system 100 show the user the photos for the user (e.g., “show me my photos”), the agent 168 determines that two different application capabilities included in the application capabilities module 220 may fulfil the request. The orchestrator 128 may interface with the router 230 to request that the router 230 interface with the unified television application 130 to provide a message to the user 101 requesting that the user 101 clarify which application the user would like to invoke to provide the photos of the user to the display 132 (“Do you want to see photos from photo app one or photo app two?”). The user 101 may then verbally or by interacting with a user interface provided by the unified television application 130 provide a response to the request that indicates which photos application the user would like to use to provide the photos of the user on the display 132. The agent 168 receives the response and proceeds to launch the selected photos application.

In a third example, the system 100 may resolve a conversational argument. For example, a settings application on the network-connected display device 104 may provide the user 101 with the ability to adjust a brightness level of the display 132. For example, the setting application may expose a SetBrightness capability. The SetBrightness capability may be included in the application capabilities module 220. The SetBrightness capability uses a brightness_value parameter, which is represented by a percentage value from one percent to one hundred percent. The SetBrightness capability may be accompanied by a few example phrases such as “set brightness to fifty percent.” The SetBrightness capability may also use a brightness_value parameter specified as a percentage value. The user 101 may make a verbal request: “I want to change the TV luminosity”. The agent 168 may map the request to the SetBrightness capability. The agent 168 may determine that the SetBrightness capability may need a brightness_value parameter specified as a percentage value. The orchestrator 128 may interface with the router 230 to request that the router 230 interface with the unified television application 130 to provide a message to the user 101 requesting that the user 101 specify the brightness value: “OK. I can help you set the brightness of the TV. Please tell me what brightness value you want the TV set to, in percentage”. The user 101 may then verbally or by interacting with a user interface provided by the unified television application 130 provides a brightness percentage value. The agent 168 receives the response and proceeds to launch the setting application and change the brightness setting for the display 132.

In a fifth example, the system 100 may provide a cross-application user experience. For example, referring to FIG. 3, the streaming media application 302 may expose a search capability (e.g., search capability 304a) that may need a query string parameter (e.g., argument value 308). The user 101 may be viewing an entity page for the streaming media application 302 in a launcher for the unified television application 130. The launcher for the unified television application 130 may share structured context for the network-connected display device 104 with the agent 168 by providing details about an entity currently being displayed on the display 132 in a schema format to the agent 168 as shown, for example, in FIG. 5. For example, the user 101 may subscribe to the streaming media application 302, however, the user 101 may not see a watch option for the streaming media application 302 on the launcher for the unified television application 130. The user 101 may make a verbal request: “Find this on the streaming media application.” The agent 168 may map the request to the search capability 304a for the streaming media application 302. The agent 168 may determine that the user 101 is viewing the entity in the launcher for the unified television application 130. The agent 168 may use the provided structured context for the network-connected display device 104 to extract a name for the entity currently being displayed on the display 132. The agent 168 may invoke the search capability (e.g., search capability 304a) for the streaming media application 302 and include the name for the entity as a search string (e.g., argument value 308). The invoking of the search capability for the streaming media application 302 launches the streaming media application 302 and the search for the requested media content as specified by the argument value 308.

Referring to FIGS. 1A-C, the mobile computing device 102 may be configured to execute the TV application 110. The mobile computing device 102 may include the mobile computing device display 108 configured to display the UI 114. A user may interact with the UI 114 to set up, control, and interact with the TV application 110. In some implementations, as described, the TV application 110 may display the virtual remote control 138 in the UI 114 allowing the user 101 to interact with and control the network-connected display device 104.

The mobile computing device 102 may be any type of computing device that includes one or more processors (processor(s) 140), one or more memory devices (memory device(s) 142), and an operating system 144. The mobile computing device 102 may be a smartphone, a tablet, a wearable device, a laptop computer, or a desktop computer. In some implementations, the operating system 144 may be system software that manages computer hardware, software resources, and provides common services for computing programs.

In some implementations, the mobile computing device 102 may be a tablet, a smartphone, or a wearable. In these implementations, the operating system 144 may be referred to as a mobile operating system. The mobile operating system may be configured to execute on devices that, in general, include display devices that may be smaller in size than, for example, a display device included in a laptop computer or a desktop computer. In some implementations, the mobile computing device 102 may be a laptop computer. In these implementations, the operating system may be referred to as a laptop or desktop operating system. In these implementations, the operating system 144 may be an operating system designed for a display that is larger in size than that included in a tablet, a smartphone, or a wearable.

In some implementations, the media adapter 107 (e.g., a casting device, a media streaming device, a media streaming player) may be interfaced with or connected to the network-connected display device 104. In some implementations, the user 101 may connect to and interact with the media adapter 107 by way of the network-connected display device 104 using a server-side TV application 116 installed on the server computer 106. The network-connected display device 104 may be communicatively coupled or connected to the server computer 106 by way of the network 150. In some implementations, referring to FIGS. 1A-C, the user 101 may connect to and interact with the media adapter 107 using the TV application 110 installed on the mobile computing device 102.

In some implementations, the user 101 may connect to and interact with the media adapter 107 using a media adapter remote control device 113. In some implementations, the TV application 110 may render the virtual remote control 138 for use with the media adapter 107. The virtual remote control 138 may allow the mobile computing device 102 to act as a remote control for the media adapter 107. The user 101 may interact with the virtual remote control 138 and/or the media adapter remote control device 113 when interacting with the media adapter 107. The user 101 may provide spoken word voice commands to the virtual remote control 138 and/or the media adapter remote control device 113 when interacting with the media adapter 107. For example, the media adapter remote control device 113 may include a microphone. The user 101 may provide spoken word voice commands to the microphone included in the media adapter remote control device 113. The media adapter 107 may receive the spoken word voice commands from the media adapter remote control device 113. The media adapter 107 may transmit, send, or provide the received spoken word voice commands as voice data to the voice-based TV assistant application 118 on the network-connected display device 104.

The media adapter 107 may interact with and communicate with the media content providers 160, the server computer 106, and the mobile computing device 102 when providing media content to the network-connected display device 104. In some implementations, the media adapter 107 may be embedded in and/or an integrated part of the network-connected display device 104.

The media content providers 160 may include a variety of streaming service and media content sources and service platforms. The media adapter 107 may facilitate providing (e.g., streaming) media content (e.g., streaming video such as movies, TV shows, etc.) from one or more streaming services included in the media content providers 160 to the network-connected display device 104. For example, the media adapter 107 may directly connect to a connector on the network-connected display device 104 by way of connection 165. The media adapter 107 may provide digital video and/or audio to the network-connected display device 104. For example, the media adapter 107 may connect to a high-definition multimedia interface (HDMI) connector included in the network-connected display device 104. Examples of the media adapter 107 may include, but are not limited to, a set-top box, a television box, and a streaming media adapter.

The user 101 may connect to and interact with the media adapter 107 using the TV application 110 installed on the mobile computing device 102. The user, interacting with the TV application 110, may select streaming services (e.g., free services, subscription-based services) for viewing media content on the network-connected display device 104. As described, the media adapter 107 can facilitate the interface between the media content providers 160 and the network-connected display device 104 that the user 101 uses to view media content (e.g., streaming media content, movies, TV shows, etc.).

In some implementations, the mobile computing device 102 may connect to or interface with the media adapter 107 by way of a wireless communication link 163b. Wireless communication links 163a-e may be short-range wireless connections such as a Bluetooth connection. In some examples, wireless communication links 163a-e may be a Wi-Fi (e.g., direct Wi-Fi) connection.

The media adapter 107 may be any type of computing device that includes one or more processors (processor(s) 170), one or more memory devices (memory device(s) 172), and an operating system 174. In some implementations, the processor(s) 170 may include a system on a chip (SoC). The SoC may include a central processing unit (CPU), a graphic processing unit (GPU), one or more memory interfaces, and one or more input/output interfaces and devices. In some implementations, the operating system 174 may be system software that manages computer hardware, software resources, and provides common services for computing programs.

The network-connected display device 104 may execute the unified television application 130. The unified television application 130 may interface with a server-side television (TV) application 116. The unified media platform (UMP) 158 may interface with the unified television application 130 executing on the network-connected display device 104 and the media content providers 160 to provide media content to the network-connected display device 104.

The unified media platform (UMP) 158 may provide or serve media content items from the media content providers 160 to the network-connected display device 104 by way of the media adapter 107. The network-connected display device 104 may execute the unified television application 130 that may interface with the server-side TV application 116 by way of the media adapter 107. The server-side TV application 116 may interface with the unified television application 130 to facilitate providing of the network-connected display device 104 when the network-connected display device 104 is turned on by the user 101.

In some implementations, the network-connected display device 104 may be configured to execute the unified television application 130. For example, the network-connected display device 104 may be a smart television. For example, a smart television may be a network-connected television that may connect to media content providers (e.g., media content providers 160) by way of a network (e.g., the network 150). The media content providers may source media content to the smart television. In these implementations, a user may interact with the unified television application 130 to access media content from the media content providers 160. The unified television application 130 may interface with the server computer 106, and specifically with the server-side TV application 116. The unified television application 130 may provide similar functionality to the user as that provided by an application executing on the media adapter 107. For example, executing the unified television application 130 by the network-connected display device 104 allows the network-connected display device 104 to obtain a media content recommendation stream from the server computer 106.

The network-connected display device 104 may be configured to connect to the network 150. In some implementations, the network-connected display device 104 is a television (e.g., a smart television (TV)). The network-connected display device 104 may include one or more processors (processor(s) 156), one or more memory devices (memory device(s) 152), and an operating system (OS) 154. The operating system 154 may execute (or assist with executing) the unified television application 130.

In some implementations, the operating system 154 may be a browser application. A browser application is a web browser configured to access information on the Internet by way of a network (e.g., the network 150). A browser application may launch one or more browser tabs in the context of one or more browser windows in the browser application. In some implementations, the operating system 154 is a Linux-based operating system configured to execute (or assist with executing) the unified television application 130.

The system 100 may include one or more server computers (e.g., the server computer 106, the application server 190) configured to interface with the mobile computing device 102, the media adapter 107, the media content providers 160, and the network-connected display device 104 by way of the network 150. In some implementations, the network 150 may establish a wireless communication link between the network-connected display device 104, the mobile computing device 102, the media adapter 107, the media content providers 160, the server computer 106, and the application server 190.

The mobile computing device 102 may include the mobile computing device display 108. In some implementations, the mobile computing device display 108 is a display device such as a liquid crystal display (LCD), a light-emitting diode (LED) display, an organic light-emitting diode (OLED) display, or an active-matrix organic light-emitting diode (AMOLED) display. The network-connected display device 104 may include the display 132. In some implementations, the display 132 is a display device such as a liquid crystal display (LCD), a light-emitting diode display (LED) display, a plasma display, a quantum dot light-emitting diode display (QLED) display, or an organic light-emitting diode (OLED) display.

The processor(s) 156, the processor(s) 140, the processor(s) 170, and the processor(s) 180 may be formed in a substrate configured to execute one or more machine executable instructions or pieces of software, firmware, or a combination thereof. The processor(s) 156, the processor(s) 140, the processor(s) 170, and the processor(s) 180 may be semiconductor-based. For example, the processor(s) 156, the processor(s) 140, the processor(s) 170, and the processor(s) 180 may include semiconductor material that can perform digital logic.

The memory device(s) 152, the memory device(s) 142, the memory device(s) 172, and the memory device(s) 182 may include main memory that stores information in a format that can be read and/or executed by the processor(s) 156, the processor(s) 140, the processor(s) 170, and the processor(s) 180 respectively. The memory device(s) 152, the memory device(s) 142, the memory device(s) 172, and the memory device(s) 182 may include one or more random-access memory (RAM) devices and/or one or more read-only memory (ROM) devices.

The memory device(s) 152, memory device(s) 142, the memory device(s) 172, and the memory device(s) 182 may store applications that, when executed by the processor(s) 156, the processor(s) 140, the processor(s) 170, and the processor(s) 180, respectively, perform operations. For example, the memory device(s) 142 may store the operating system 144 and the TV application 110 that, when executed by the processor(s) 140, may perform operations on the mobile computing device 102. For example, the memory device(s) 152 may store the operating system 154 and the unified television application 130 that, when executed by the processor(s) 156, may perform operations on the network-connected display device 104.

In some implementations, the memory device(s) 182 may represent any kind of (or multiple kinds of) memory (e.g., RAM, flash, cache, disk, tape, etc.). In some implementations, the memory device(s) 182 may include external storage, e.g., memory physically remote from but accessible by the server computer 106. The server computer 106 may include one or more modules, engines, or applications representing specially programmed software. In some implementations, the server computer 106 may include the operating system 184, the server-side TV application 116, the UMP 158, the server-side orchestrator 131, the server-side TV application 116, processor(s) 180, and the device(s) 182. For example, the memory device(s) 182 may store the operating system 184, the server-side TV application 116, the UMP 158, the server-side orchestrator 131, and the server-side TV application 116 that, when executed by the processor(s) 180, may perform operations on server computer 106 to implement one or more of the methods and processes described herein.

The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within the network 150. The network 150 may further include any number of hardwired and/or wireless connections. The network 150 may be, for example, communications networks having one or more types of topologies, including but not limited to the Internet, intranets, local area networks (LANs), cellular networks, Ethernet, Storage Area Networks (SANs), telephone networks, and Bluetooth personal area networks (PAN). In some implementations, two or more devices in a sub-network may be coupled by way of a wired connection, while at least some of the devices in the same sub-network are coupled by way of a local radio communication network (e.g., ZigBee, Z-Wave, Insteon, Bluetooth, Wi-Fi and other radio communication networks).

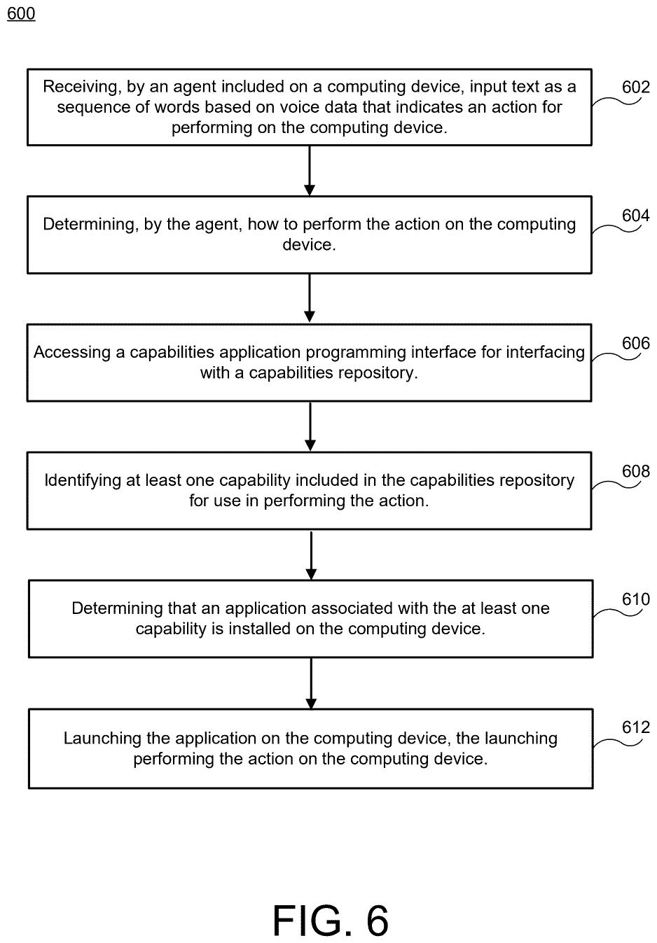

FIG. 6 illustrates a flowchart depicting example operations for implementing an extensible conversational system intelligence agent according to implementations described throughout this disclosure. Although the flowchart 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion. The operations may define a computer-implemented method. Although the flowchart 600 is described with reference to the system 100 of FIG. 1C, the flowchart 600 may be executed according to any of the figures discussed herein. In some examples, the operations of the flowchart 600 are executed by the network-connected display device 104.

Operation 602 includes receiving, by an agent included on a computing device, input text as a sequence of words based on voice data that indicates an action for performing on the computing device.

Operation 604 includes determining, by the agent, how to perform the action on the computing device.

Operation 606 includes accessing a capabilities application programming interface for interfacing with a capabilities repository.

Operation 608 includes identifying at least one capability included in the capabilities repository for use in performing the action.

Operation 610 includes determining that an application associated with the at least one capability is installed on the computing device.

Operation 612 includes launching the application on the computing device, the launching performing the action on the computing device.

In some examples, the techniques described herein relate to a method including: receiving, by an agent included on a computing device, input text as a sequence of words based on voice data that indicates an action for performing on the computing device; determining, by the agent, how to perform the action on the computing device, the determining including: accessing a capabilities application programming interface for interfacing with a capabilities repository; identifying at least one capability included in the capabilities repository for use in performing the action; and determining that an application associated with the at least one capability is installed on the computing device; and launching the application on the computing device, the launching performing the action on the computing device.

In some examples, the techniques described herein relate to a method, further including: receiving, by the agent, a structured formatted file that includes capabilities associated with the application; and including the capabilities in the capabilities repository in association with the application.

In some examples, the techniques described herein relate to a method, further including, based on analyzing a screen shot of an application executing in the computing device, determining at least one capability for including in the capabilities repository in association with the application.

In some examples, the techniques described herein relate to a method, further including synchronizing another capabilities repository included on another computing device with the capabilities repository, the synchronizing providing cross-device capabilities.

In some examples, the techniques described herein relate to a method, wherein the voice data is provided by a remote control device communicatively coupled to the computing device.

In some examples, the techniques described herein relate to a method, wherein determining how to perform the action on the computing device further includes: identifying at least one capability included in a central capabilities repository for use in performing the action; determining that an application associated with the at least one capability included in the central capabilities repository is included in a web store application repository; and sending a request to an application server to download the application associated with the at least one capability included in the central capabilities repository to the computing device.

In some examples, the techniques described herein relate to a method, wherein determining how to perform the action on the computing device further includes: accessing a context application programming interface for interfacing with a context repository; and identifying at least one context included in the context repository for use in performing the action.

In some examples, the techniques described herein relate to a method, further including determining that the input text is a phrase associated with the application.

In some examples, the techniques described herein relate to a method, wherein the computing device is a smart television.

In some examples, the techniques described herein relate to a non-transitory computer-readable medium storing executable instructions that when executed by at least one processor of a computing device cause the at least one processor to execute operations, the operations including: receiving, by an agent included on the computing device, input text as a sequence of words based on voice data that indicates an action for performing on the computing device; determining, by the agent, how to perform the action on the computing device, the determining including: accessing a capabilities application programming interface for interfacing with a capabilities repository; identifying at least one capability included in the capabilities repository for use in performing the action; and determining that an application associated with the at least one capability is installed on the computing device; and launching the application on the computing device, the launching performing the action on the computing device.

In some examples, the techniques described herein relate to a non-transitory computer-readable medium, wherein the operations further include: receiving, by the agent, a structured formatted file that includes capabilities associated with the application; and including the capabilities in the capabilities repository in association with the application.

In some examples, the techniques described herein relate to a non-transitory computer-readable medium, wherein the operations further include, based on analyzing a screen shot of an application executing in the computing device, determining at least one capability for including in the capabilities repository in association with the application.

In some examples, the techniques described herein relate to a non-transitory computer-readable medium, wherein the operations further include synchronizing another capabilities repository included on another computing device with the capabilities repository, the synchronizing providing cross-device capabilities.

In some examples, the techniques described herein relate to a non-transitory computer-readable medium, wherein the voice data is provided by a remote control device communicatively coupled to the computing device.

In some examples, the techniques described herein relate to a non-transitory computer-readable medium, wherein determining how to perform the action on the computing device further includes: identifying at least one capability included in a central capabilities repository for use in performing the action; determining that an application associated with the at least one capability included in the central capabilities repository is included in a web store application repository; and sending a request to an application server to download the application associated with the at least one capability included in the central capabilities repository to the computing device.

In some examples, the techniques described herein relate to a non-transitory computer-readable medium, wherein determining how to perform the action on the computing device further includes: accessing a context application programming interface for interfacing with a context repository; and identifying at least one context included in the context repository for use in performing the action.

In some examples, the techniques described herein relate to a system including: at least one processor; and a non-transitory computer-readable medium storing instructions that when executed by the at least one processor cause the system to: receive input text as a sequence of words based on voice data that indicates an action for performing on the system; determine how to perform the action on the system, the determining including: accessing a capabilities application programming interface for interfacing with a capabilities repository; identifying at least one capability included in the capabilities repository for use in performing the action; and determining that an application associated with the at least one capability is installed on the system; and launch the application on the system, the launching performing the action on the system.

In some examples, the techniques described herein relate to a system, wherein the instructions when executed by the at least one processor further cause the system to: receive a structured formatted file that includes capabilities associated with the application; and include the capabilities in the capabilities repository in association with the application.

In some examples, the techniques described herein relate to a system, wherein the instructions when executed by the at least one processor further cause the system to, based on analyzing a screen shot of an application executing in the system, determine at least one capability for including in the capabilities repository in association with the application.

In some examples, the techniques described herein relate to a system, wherein the instructions when executed by the at least one processor further cause the system to synchronize another capabilities repository included on another system with the capabilities repository, the synchronizing providing cross-device capabilities.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or non-transitory medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

Further to the descriptions above, a user may be provided with controls allowing the user to make an election as to both if and when systems, programs, or features described herein may enable collection of user information (e.g., a user's preferences, a user's current location, a user's credentials, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

What is claimed is:

1. A method comprising:
receiving, by an agent included on a computing device, input text as a sequence of words based on voice data that indicates an action for performing on the computing device;
determining, by the agent, how to perform the action on the computing device, the determining comprising:
accessing a capabilities application programming interface for interfacing with a capabilities repository;
identifying at least one capability included in the capabilities repository for use in performing the action; and
determining that an application associated with the at least one capability is installed on the computing device; and
launching the application on the computing device, the launching performing the action on the computing device.

2. The method of claim 1, further comprising:
receiving, by the agent, a structured formatted file that includes capabilities associated with the application; and
including the capabilities in the capabilities repository in association with the application.

3. The method of claim 1, further comprising, based on analyzing a screen shot of an application executing in the computing device, determining at least one capability for including in the capabilities repository in association with the application.

4. The method of claim 1, further comprising synchronizing another capabilities repository included on another computing device with the capabilities repository, the synchronizing providing cross-device capabilities.

5. The method of claim 1, wherein the voice data is provided by a remote control device communicatively coupled to the computing device.

6. The method of claim 1, wherein determining how to perform the action on the computing device further comprises:
identifying at least one capability included in a central capabilities repository for use in performing the action;
determining that an application associated with the at least one capability included in the central capabilities repository is included in a web store application repository; and
sending a request to an application server to download the application associated with the at least one capability included in the central capabilities repository to the computing device.

7. The method of claim 1, wherein determining how to perform the action on the computing device further comprises:
accessing a context application programming interface for interfacing with a context repository; and
identifying at least one context included in the context repository for use in performing the action.

8. The method of claim 1, further comprising determining that the input text is a phrase associated with the application.

9. The method of claim 1, wherein the computing device is a smart television.

10. A non-transitory computer-readable medium storing executable instructions that when executed by at least one processor of a computing device cause the at least one processor to execute operations, the operations comprising:
receiving, by an agent included on the computing device, input text as a sequence of words based on voice data that indicates an action for performing on the computing device;
determining, by the agent, how to perform the action on the computing device, the determining comprising:
accessing a capabilities application programming interface for interfacing with a capabilities repository;
identifying at least one capability included in the capabilities repository for use in performing the action; and
determining that an application associated with the at least one capability is installed on the computing device; and
launching the application on the computing device, the launching performing the action on the computing device.

11. The non-transitory computer-readable medium of claim 10, wherein the operations further comprise:
receiving, by the agent, a structured formatted file that includes capabilities associated with the application; and
including the capabilities in the capabilities repository in association with the application.

12. The non-transitory computer-readable medium of claim 10, wherein the operations further comprise, based on analyzing a screen shot of an application executing in the computing device, determining at least one capability for including in the capabilities repository in association with the application.

13. The non-transitory computer-readable medium of claim 10, wherein the operations further comprise synchronizing another capabilities repository included on another computing device with the capabilities repository, the synchronizing providing cross-device capabilities.

14. The non-transitory computer-readable medium of claim 10, wherein the voice data is provided by a remote control device communicatively coupled to the computing device.

15. The non-transitory computer-readable medium of claim 10, wherein determining how to perform the action on the computing device further comprises:
identifying at least one capability included in a central capabilities repository for use in performing the action;
determining that an application associated with the at least one capability included in the central capabilities repository is included in a web store application repository; and
sending a request to an application server to download the application associated with the at least one capability included in the central capabilities repository to the computing device.

16. The non-transitory computer-readable medium of claim 10, wherein determining how to perform the action on the computing device further comprises:
accessing a context application programming interface for interfacing with a context repository; and
identifying at least one context included in the context repository for use in performing the action.

17. A system comprising:
at least one processor; and
a non-transitory computer-readable medium storing instructions that when executed by the at least one processor cause the system to:
receive input text as a sequence of words based on voice data that indicates an action for performing on the system;
determine how to perform the action on the system, the determining comprising:
accessing a capabilities application programming interface for interfacing with a capabilities repository;
identifying at least one capability included in the capabilities repository for use in performing the action; and
determining that an application associated with the at least one capability is installed on the system; and
launch the application on the system, the launching performing the action on the system.

18. The system of claim 17, wherein the instructions when executed by the at least one processor further cause the system to:
receive a structured formatted file that includes capabilities associated with the application; and
include the capabilities in the capabilities repository in association with the application.

19. The system of claim 17, wherein the instructions when executed by the at least one processor further cause the system to, based on analyzing a screen shot of an application executing in the system, determine at least one capability for including in the capabilities repository in association with the application.

20. The system of claim 17, wherein the instructions when executed by the at least one processor further cause the system to synchronize another capabilities repository included on another system with the capabilities repository, the synchronizing providing cross-device capabilities.
